(19) United States
(12) Patent Application Publication
(10) Pub. No.: US 2012/0120355 A1
(43) Pub. Date: May 17, 2012

(54) STRUCTURE OF REFLECTIVE DISPLAY PANEL

(75) Inventors: YUET WING LI, TAINAN COUNTY (TW); KUAN-HSU FAN-CHIANG, TAINAN COUNTY (TW); CHIEN-LIANG WU, TAINAN COUNTY (TW)

(73) Assignee: HIMAX DISPLAY, INC., TAINAN COUNTY (TW)

(21) Appl. No.: 12/945,401

(22) Filed: Nov. 12, 2010

(51) Int. Cl. G02F 1/1335

(52) U.S. Cl. 349/117

(57) ABSTRACT

A structure of a reflective display panel including a silicon substrate, a liquid crystal layer and a stacked compensation film layer is provided. The liquid crystal layer disposed on the silicon substrate has a first phase retardation which is within a first retardation range. The stacked compensation film layer disposed on the liquid crystal layer has a second phase retardation which is within a second retardation range. The stacked compensation film layer is selected according to an optical characteristic of the liquid crystal layer so as to increase a contrast of the reflective display panel.

### BACKGROUND

1. Field of the Invention

The invention relates to a structure of a display panel. Particularly, the invention relates to a structure of a reflective display panel.

2. Description of Related Art

In recent years, with development of photoelectric technology and semiconductor manufacturing technology, flat panel displays are quickly developed, in which since a liquid crystal display (LCD) has advantages of low operation voltage, no irradiation, light weight and small size, etc., it gradually replaces a conventional cathode ray tube (CRT) display and becomes a main stream in the display market. For example, a reflective LCD using a liquid-crystal-on-silicon panel (LCoS panel), etc.

The LCoS panel mainly consists of a substrate fabricated by silicon wafer and an opposite substrate fabricated by a glass material. In the LCoS panel, metal oxide semiconductor (MOS) transistors are used to replace thin film transistors used in a conventional liquid crystal panel. The LCoS panel is belonged to a reflective liquid crystal display panel, in which pixel electrodes are fabricated by a metal material. Moreover, since the metal pixel electrodes almost cover a whole pixel region (especially the MOS transistors), compared to the conventional liquid crystal panel, the LCoS panel has a better optical efficiency.

However, regarding a commonly used liquid crystal mode, an optical quality thereof such as contrast, reflectance and response time, etc. is still required to be improved, so that the LCoS panel having a better optical quality is still under development.

### SUMMARY OF THE INVENTION

The invention is directed to a structure of a reflective display panel, which has a good optical quality of high contrast, high reflectance and fast response time.

The invention provides a structure of a reflective display panel, which includes a silicon substrate, a liquid crystal layer, and a stacked compensation film layer. The liquid crystal layer is disposed on the silicon substrate and has a first phase retardation, wherein the first phase retardation is within a first retardation range. The stacked compensation film layer is disposed on the liquid crystal layer and has a second phase retardation, wherein the second phase retardation is within a second retardation range. The stacked compensation film layer is selected according to an optical characteristic of the liquid crystal layer so as to increase a contrast of the reflective display panel.

In an embodiment of the invention, the liquid crystal layer has a beta angle, and the beta angle is between −10 degrees and −8 degrees relative to a direction axis.

In an embodiment of the invention, the liquid crystal layer has a twist angle, and the twist angle is between 72 degrees and 76 degrees relative to the beta angle.

In an embodiment of the invention, the first retardation range is between 200 nm and 210 nm.

In an embodiment of the invention, the stacked compensation film layer includes a first compensation film and a second compensation film. The first compensation film has a first slow axis, and an angle of the first slow axis relative to the direction axis is within a first range. The second compensation film has a second slow axis, and an angle of the second slow axis relative to the direction axis is within a second range.

In an embodiment of the invention, the first range is between 0 degree and 30 degrees, and the second range is between 90 degrees and 120 degrees.

In an embodiment of the invention, the second retardation range is between 25 nm and 140 nm.

In an embodiment of the invention, the sacked compensation film layer includes a black matrix.

In an embodiment of the invention, the structure of the reflective display panel further includes a first alignment layer and a second alignment layer. The liquid crystal layer is disposed between the first alignment layer and the second alignment layer.

In an embodiment of the invention, the structure of the reflective display panel further includes a top transparent substrate and a bottom transparent substrate.

The stacked compensation film layer is disposed between the top transparent substrate and the bottom transparent substrate.

In an embodiment of the invention, the top transparent substrate includes a black matrix.

In an embodiment of the invention, the structure of the reflective display panel further includes an optical glue. The optical glue is disposed between the top transparent substrate and the stacked compensation film layer, and between the bottom transparent substrate and the stacked compensation film layer.

In an embodiment of the invention, the structure of the reflective display panel further includes a transparent electrode layer. The transparent electrode layer is disposed between the liquid crystal layer and the stacked compensation film layer.

In an embodiment of the invention, the structure of the reflective display panel further includes an anti-reflection layer. The anti-reflection layer is disposed on the stacked compensation film layer.

In an embodiment of the invention, the reflective display panel is a liquid-crystal-on-silicon panel (LCoS panel).

According to the above descriptions, in an exemplary embodiment of the invention, the stacked compensation film layer is selected according to an optical characteristic of the liquid crystal layer, so as to increase a contrast and a reflectance of the reflective display panel and shorten an response time thereof.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic diagram illustrating a structure of a reflective display panel according to an embodiment of the invention.

FIG. 1B shows the definitions of the slow axis angle, the beta angle, and the twist angle listed in table I and table II.

FIG. 2 shows a white spectral response of the reflective display panel structure of the embodiment.

FIG. 3 shows a dark spectral response of the reflective display panel structure of the embodiment.

FIG. 4 is a schematic diagram illustrating a structure of a reflective display panel according to another embodiment of the invention.

### DETAILED DESCRIPTION OF DISCLOSED EMBODIMENTS

The most dominated liquid crystal mode for a liquid-crystal-on-silicon panel (LCoS panel) is MTN-90 (mixed-mode twist nematic-90). An optical characteristic such as a contrast, a reflectance and a response time, etc. of the LCoS panel using such liquid crystal mode is still required to be improved.

Therefore, in an exemplary embodiment of the invention, the LCoS panel includes a stacked compensation film layer, and stacked compensation layers with different optical characteristics can be selected according to the optical characteristic of a liquid crystal layer, so as to increase a contrast and a reflectance of the LCoS panel, and shorten an optical response time thereof.

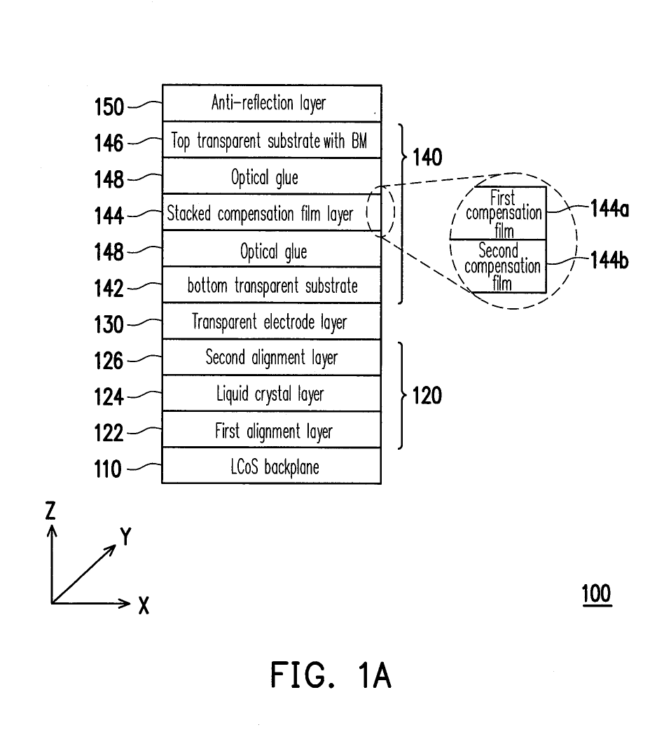

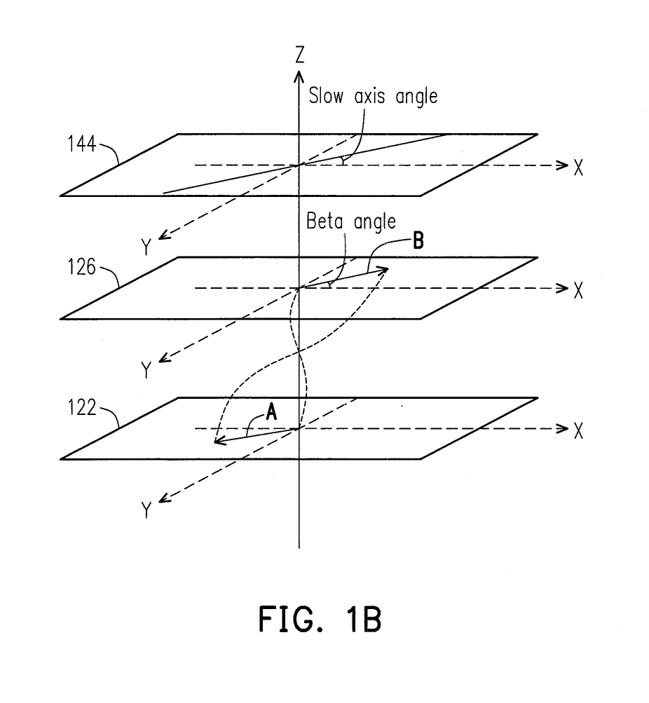

FIG. 1A is a schematic diagram illustrating a structure of a reflective display panel according to an embodiment of the invention. Referring to FIG. 1A, in the present embodiment, the reflective display panel 100 is, for example, a LCoS panel.

The reflective display panel 100 includes a LCoS backplane 110 (a silicon substrate), and a first layered structure 120, a transparent electrode layer 130, a second layered structure 140 and an anti-reflection layer 150 are sequentially disposed on the LCoS backplane 110.

The first layered structure 120 includes a first alignment layer 122, a liquid crystal layer 124 and a second alignment layer 126, wherein the liquid crystal layer 124 is disposed between the first alignment layer 122 and the second alignment layer 126.

The second layered structure 140 includes a bottom transparent substrate 142, a stacked compensation film layer 144 and a top transparent substrate 146, wherein the stacked compensation film layer 144 is disposed between the top transparent substrate 146 and the bottom transparent substrate 142. In the present embodiment, the top and bottom transparent substrates 146 and 142 are, for example, respectively a glass substrate with a refractive index of 1.51 (n=1.51), though the invention is not limited thereto. Moreover, in the present embodiment, a black matrix used for shielding light is formed by a metal material, and is disposed in the top transparent substrate 146.

In the present embodiment, the second layered structure 140 further includes an optical glue 148, which is disposed between the top transparent substrate 146 and the stacked compensation film layer 144, and between the bottom transparent substrate 142 and the stacked compensation film layer 144, so as to adhere the stacked compensation film layer 144 to the top and bottom transparent substrates 146 and 142. It should be noticed that selection of a material of the optical glue 148 has a principle of index matching.

In other words, in the present embodiment, the liquid crystal layer 124 is disposed above the LCoS backplane 110, and the stacked compensation film layer 144 is disposed above the liquid crystal layer 124. Moreover, according to descriptions of the first layered structure 120 and the second layered structure 140, it is known that the transparent electrode layer 130 is disposed between the liquid crystal layer 124 and the stacked compensation film layer 144, and the anti-reflection layer 150 is disposed above the stacked compensation film layer 144 for reducing reflection of stray light. In the present embodiment, the transparent electrode layer 130 is, for example, an indium tin oxide (ITO) electrode of index matching.

Following table I and table II list optical characteristics of the stacked compensation film layer 144 and the liquid crystal layer 124.

TABLE I
Stacked compensation film layer

| | | |
|---|---|---|
| Minimum | Maximum | Remark |

First compensation film

| | | | |
|---|---|---|---|
| Phase retardation (nm) | 25 | 140 | |
| Slow axis angle (degree) | 0 | 30 | Relative to X-axis |

Second compensation film

| | | | |
|---|---|---|---|
| Phase retardation (nm) | 25 | 140 | |
| Slow axis angle (degree) | 90 | 120 | Relative to X-axis |

TABLE II
Liquid crystal layer

| | Minimum | Maximum | Remark |
|---|---|---|---|
| Twist angle (degree) | 72 | 76 | Relative to beta angle |
| Beta angle (degree) | −10 | −8 | Relative to X-axis |
| Phase retardation (nm) | 200 | 210 | |

In the present embodiment, the stacked compensation film layer 144 includes a first compensation film 144a and a second compensation film 144b, as that shown in FIG. 1A. According to the table I, it is known that an angle of the slow axis of the first compensation film 144a relative to the X-axis is between 0 degree and 30 degrees, and an angle of the slow axis of the second compensation film 144b relative to the X-axis is between 90 degrees and 120 degrees. Moreover, phase retardations of the first compensation film 144a and the second compensation film 144b are between 25 nm and 140 nm. In other words, a phase retardation of the stacked compensation film layer 144 is within a retardation range of 25 nm to 140 nm.

On the other hand, according to the table II, it is know that a phase retardation of the liquid crystal layer 120 of the present embodiment is within a retardation range of 200 nm-210 nm. Moreover, the beta angle of the liquid crystal layer 120 relative to the X-axis is between −10 degrees and −8 degrees. The twist angle of the liquid crystal layer 120 relative to the beta angle is between 72 degrees and 76 degrees.

In the present embodiment, the phase retardation of the liquid crystal layer 120 is within a retardation range, and within such retardation range, when the phase retardation of the liquid crystal layer 120 is selected, the beta angle and the twist angle of the liquid crystal layer 120 are correspondingly determined. Namely, one phase retardation corresponds to a set of the beta angle and the twist angle, and angle ranges of the beta angle and the twist angle are as that shown in the table II.

FIG. 1B shows the definitions of the slow axis angle, the beta angle, and the twist angle listed in table I and table II. Referring to FIG. 1B, in the present embodiment, the slow axis angle is defined as the angle between the slow axis of the stacked compensation film layer 144 and the X-axis. The rubbing directions of the first alignment layer 122 and the second alignment layer 126 are respectively represented by vectors A and B. The beta angle of the liquid crystal layer 120 relative to the X-axis is defined as the angle between the vector B and the X-axis, and the twist angle of the liquid crystal layer 120 relative to the beta angle is as the angle between the vectors A and B.

On the other hand, the phase retardation of the stacked compensation film layer 144 is within another retardation range. Therefore, when the phase retardations of the first compensation film 144a and the second compensation film 144b are selected, the angles of the slow axes thereof relative to the X-angle are correspondingly determined. It should be noticed that in the present embodiment, the phase retardations of the first compensation film 144a and the second compensation film 144b are the same, though the angles of the slow axes thereof relative to the X-angle are different, so as to provide a compensation effect.

Therefore, in the structure of the reflective display panel 100, when the liquid crystal layer 120 is determined, the first compensation film 144a and the second compensation film 144 of the stacked compensation film layer 144 can be selected according to the optical characteristic of the liquid crystal layer 120 shown in the table I, so as to increase a contrast of the reflective display panel 100.

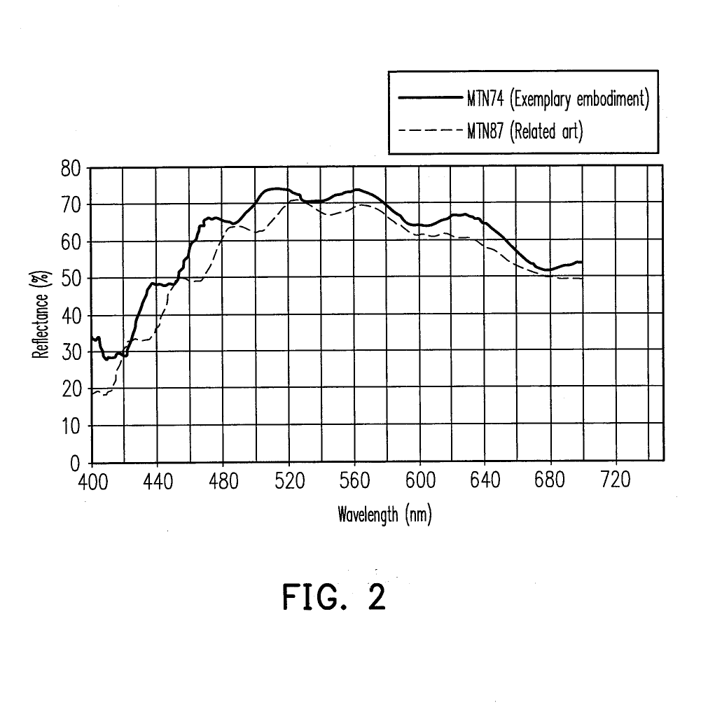

FIG. 2 shows a white spectral response of the reflective display panel structure of the embodiment, in which a horizontal axis represents wavelengths (nm), and a vertical axis represents reflectance (%). According to FIG. 2, it is known that the reflectance of the reflective display panel structure using the liquid crystal layer and the stacked compensation film layer of the present embodiment is effectively increased. In view of the whole structure, compared to the reflectance 66% of a liquid crystal mode MTN-87, the liquid crystal mode of the reflective display panel structure of the present embodiment is MTN-74, and in collaboration with the suitable stacked compensation film layer, the reflectance thereof is increased to 70%.

In other words, compared to the related technique, a white reflectance of the reflective display panel structure using the liquid crystal layer and the stacked compensation film layer of the present embodiment can be increased by at least 3% (from 66% to 70%).

Moreover, in the present embodiment, the reflectance of the reflective display panel can be effective increased within a wavelength range 460 nm to 640 nm, and especially in a blue band. When the reflectance of the blue light is significantly increased, it avails increasing a whole brightness of the reflective display panel when it reaches a white balance.

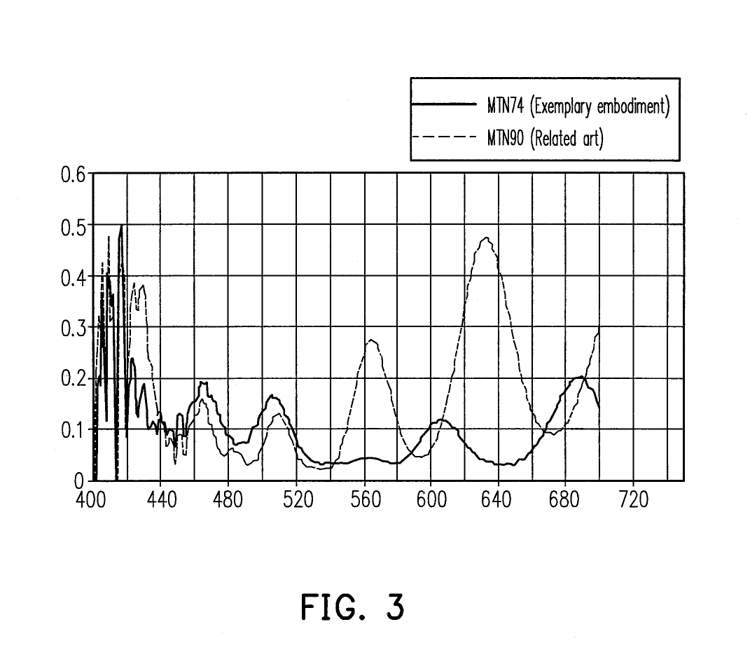

FIG. 3 shows a dark spectral response of the reflective display panel structure of the embodiment, in which a horizontal axis represents wavelengths (nm), and a vertical axis represents reflectance (%). According to FIG. 3, it is known that a contrast of the reflective display panel structure using the liquid crystal layer and the stacked compensation film layer of the present embodiment is effectively increased. In view of the whole structure, compared to a liquid crystal mode MTN-90, when an operation voltage is 6.5 volts, a contrast of the liquid crystal mode MTN-90 is 508, while regarding the reflective display panel structure using the suitable stacked compensation film layer of the present embodiment, when the operation voltage is 6 volts, the contrast thereof is increased to 1058.

In other words, compared to the conventional technique, the contrast of the reflective display panel structure using the liquid crystal layer and the stacked compensation film layer of the present embodiment is increased by at least 200% (from 508 to 1058) as the operation voltage is decreased by 7% (from 6.5 volts to 6 volts). Moreover, in the present embodiment, a response time of the reflective display panel is reduced to 1.34 ms from 1.6 ms, i.e. reduced by 19%.

Moreover, regarding the response for a single wavelength laser, the contrast of the reflective display panel of the present embodiment is not liable to be varied along with fabrication parameters, so that a stability of the contrast is effectively increased.

In the present embodiment, the black matrix is disposed in the top transparent substrate 146, though the invention is not limited thereto, and in other embodiments, the black matrix can be disposed in the stacked compensation film layer.

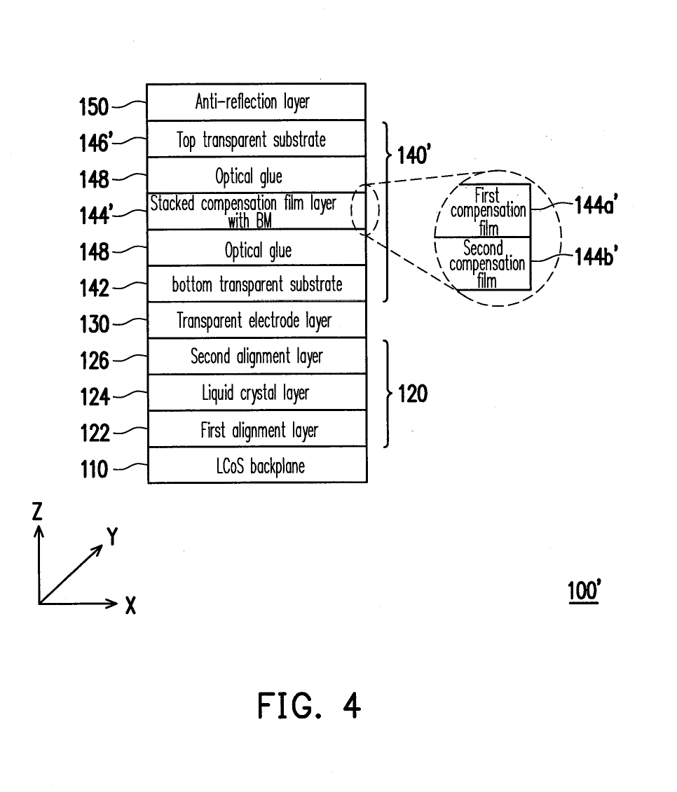

FIG. 4 is a schematic diagram illustrating a structure of a reflective display panel according to another embodiment of the invention. Referring to FIG. 4, the reflective display panel 100′ of the present embodiment is similar to the reflective display panel 100 of FIG. 1A, and a difference therebetween is that in the reflective display panel 100′, a black matrix (not shown) is disposed in a stacked compensation film layer 144′.

The black matrix disposed in the stacked compensation film layer 144′ is not limited to be fabricated by the metal material, which can also be fabricated by black photoresist, so as to reduce a fabrication cost of the reflective display panel. Moreover, the black matrix in the stacked compensation film layer 144′ can be fabricated through inject printing, so as to simplify a fabrication process.

In summary, in an exemplary embodiment of the invention, the stacked compensation film layer is selected according to an optical characteristic of the liquid crystal layer, so as to increase a contrast and a reflectance of the reflective display panel, and shorten an optical response time thereof.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A structure of a reflective display panel, comprising:
a silicon substrate;
a liquid crystal layer disposed on the silicon substrate and having a first phase retardation, wherein the first phase retardation is within a first retardation range; and
a stacked compensation film layer disposed on the liquid crystal layer, and having a second phase retardation, wherein the second phase retardation is within a second retardation range, and the stacked compensation film layer is selected according to an optical characteristic of the liquid crystal layer so as to increase a contrast of the reflective display panel.

2. The structure of the reflective display panel as claimed in claim 1, wherein the liquid crystal layer has a beta angle, and the beta angle is between −10 degrees and −8 degrees relative to a direction axis.

3. The structure of the reflective display panel as claimed in claim 2, wherein the liquid crystal layer has a twist angle, and the twist angle is between 72 degrees and 76 degrees relative to the beta angle.

4. The structure of the reflective display panel as claimed in claim 3, wherein the first retardation range is between 200 nm and 210 nm.

5. The structure of the reflective display panel as claimed in claim 1, wherein the stacked compensation film layer comprises:
a first compensation film, having a first slow axis, and an angle of the first slow axis relative to a direction axis being within a first range; and
a second compensation film having a second slow axis, and an angle of the second slow axis relative to the direction axis is within a second range.

6. The structure of the reflective display panel as claimed in claim 5, wherein the first range is between 0 degree and 30 degrees, and the second range is between 90 degrees and 120 degrees.

7. The structure of the reflective display panel as claimed in claim 6, wherein the second retardation range is between 25 nm and 140 nm.

8. The structure of the reflective display panel as claimed in claim 1, wherein the sacked compensation film layer comprises a black matrix.

9. The structure of the reflective display panel as claimed in claim 1, further comprising a first alignment layer and a second alignment layer, wherein the liquid crystal layer is disposed between the first alignment layer and the second alignment layer.

10. The structure of the reflective display panel as claimed in claim 1, further comprising a top transparent substrate and a bottom transparent substrate, wherein the stacked compensation film layer is disposed between the top transparent substrate and the bottom transparent substrate.

11. The structure of the reflective display panel as claimed in claim 10, wherein the top transparent substrate comprises a black matrix.

12. The structure of the reflective display panel as claimed in claim 10, further comprising an optical glue disposed between the top transparent substrate and the stacked compensation film layer and between the bottom transparent substrate and the stacked compensation film layer.

13. The structure of the reflective display panel as claimed in claim 1, further comprising a transparent electrode layer disposed between the liquid crystal layer and the stacked compensation film layer.

14. The structure of the reflective display panel as claimed in claim 1, further comprising an anti-reflection layer disposed on the stacked compensation film layer.

15. The structure of the reflective display panel as claimed in claim 1, wherein the reflective display panel is a liquid-crystal-on-silicon panel (LCoS panel).
